(19) United States
(12) Patent Application Publication
(10) Pub. No.: US 2015/0104103 A1
(43) Pub. Date: Apr. 16, 2015

(54) SURVEILLANCE CAMERA THAT RESPECTS PRIVACY

(71) Applicant: SONY CORPORATION, Tokyo (JP)

(72) Inventor: Brant Candelore, San Diego, CA (US)

(73) Assignee: SONY CORPORATION, Tokyo (JP)

(21) Appl. No.: 14/055,353

(22) Filed: Oct. 16, 2013

(51) Int. Cl. G06K 9/00; G06T 3/00

(52) U.S. Cl. CPC G06K 9/00288; G06T 3/00; G06K 2009/4666
USPC 382/195

(57) ABSTRACT

A surveillance camera obscures human features when people are present to preserve privacy.

### FIELD OF THE INVENTION

The present application relates generally to surveillance cameras that have privacy enhancing features.

### BACKGROUND OF THE INVENTION

We are starting to be under constant surveillance—at work, at shopping malls and outdoor public places. Some of the surveillance may be objectionable. Public policy regarding what may be done with the video may not be enough. As understood herein, there may be surveillance scenarios where it may be desirable to obfuscate the identities of people in a video stream.

SUMMARY OF THE INVENTION

As is described herein, there may be degrees of obfuscation of surveillance images. Some obfuscation may be simply to interfere with automatic facial recognition algorithms. Other obfuscation would prevent recognition by other criteria, e,g. clothes, height and body build, etc.

A surveillance camera, still or video, recognizes faces in order to process the image to render faces unrecognizable by obfuscating faces, e.g., through pixilation or masking. This allows a viewer of surveillance video to know what people are doing but not exactly who may be doing it. Depending on the depth of obfuscation, in addition to general face recognition, the camera may obfuscate side profiles, the back of someone's head, as well as the entire torso or body. In the discussion below, it will be assumed that “facial features”means physical features mainly to do with the head, including the face, ears, side, and back. Another mode of obfuscation automatically adds facial features such as hair bangs, a mustache and large eyebrows to the image in order to hide the facial features. Other forms of obfuscation can include distorting, e.g., elongating or squashing, the face in the image.

Such cameras can be advertised as being “privacy cams”. The video cameras are present for security, voyeuristic, and other reasons, but on an operational basis they will not reveal facial features of people. Additionally or alternatively, the area of the image containing the facial features can be encrypted in both video camcorders and still cameras such that law enforcement operating under a warrant can obtain the keys to decrypt it. The keys can be known to the manufacturer or operator of the camera.

In another aspect a method includes determining, using a processor, whether a person imaged by a camera is recognized, and only if the person is recognized (e.g., as an individual or as a member of a group that may be identified by, e.g., members of the group wearing identifying indicia common to the members, such as ID badges), obfuscating a portion of the image corresponding to the face of the person to preserve privacy. For example, this might be more generally useful when it is known that subjects are under age, e.g. under 18 years old. And so while filming, a person might be recognized as a child or teenager, and have their facial features blurred. The recognition here is used to exclude a class of people, e.g. under age people, from having their images taken.

In another aspect, a camera includes a transceiver, a computer readable storage medium, and a processor configured for accessing the computer readable storage medium to execute instructions which configure the processor for generating a captured image of a person, and determining whether the person is individually recognized using the captured image. The processor, responsive to a determination that the person is recognized can perform one or more of:

(1) obfuscate at least a portion of the captured image corresponding to the person's face to render an obfuscated image that is not recognizable by a person viewing the obfuscated image while, if desired, leaving every other person's face in the camera's field of view in the clear. On the other hand, the processor, responsive to a determination that the person is not recognized, does not obfuscate the portion of the image corresponding to the person's face; and/or

(2) obfuscate at least a portion of the captured image corresponding to everyone else's face (not recognized) to render an obfuscated image that is not recognizable by a person viewing the obfuscated image while leaving the recognized person in the clear. On the other hand, the processor, responsive to a determination that the person is not recognized, can obfuscate the portion of the corresponding to the person's face. This may allow some privacy to those that have not agreed to have their image taken and opted in to the group to be recognized.

In some embodiments the processor determines whether the person is recognized using a face recognition algorithm. If desired, the processor determines whether the person is recognized by comparing the captured image to images in a remote database of images. Indeed, the image may be sent to a remote server for analysis and comparison to a database of images. Or, the processor can determine whether the person is recognized by comparing the captured image to images stored on the camera. The comparison further may be done by comparing a portion of the portion of the captured image corresponding to the person's profile to images in a database, and/or by comparing a portion of the captured image corresponding to the back of the person's head to images in a database. Obfuscation may be effected by pixilating the clear image, masking the clear image, adding at least one facial feature to the clear image, or a combination thereof. The processor can encrypt the portion of the captured image containing the facial or head features and store the image with both clear non-facial or non-head features, and encrypted portions of the facial or head features on or off the camera.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example privacy-enhancing surveillance camera in one intended environment; and

FIG. 2 is a flow chart of example logic.

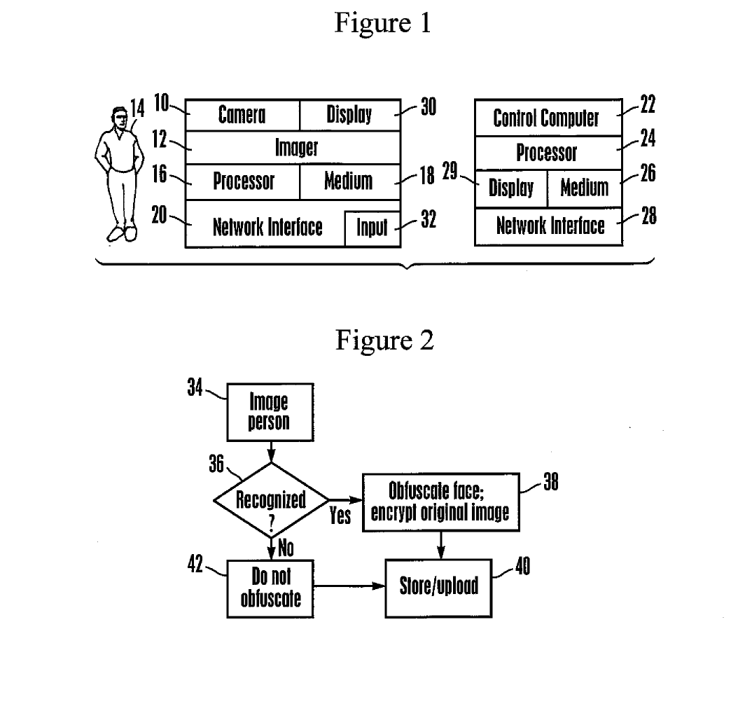

### DETAILED DESCRIPTION OF THE PREFERRED EMBODIMENT

Present principles employ facial recognition by a camcorder or still camera which otherwise may be used to help focus the image or determine when a person is smiling to determine whether to obfuscate the face of a surveilled person.

In the example shown a camera 10, which may be a still camera or a video camera, includes an imager 12 such as but not limited to charge coupled device (CCD) imagers or complementary metal-oxide-semiconductor (CMOS) imagers. Signals representing digital images of objects such as a person 14 are sent from the imager to a camera processor 16, which accesses one, or more computer readable storage media 18 such as read-only memory (ROM) and variants thereof, random access memory and variants thereof and physically embodies as, for example, disk-based or solid-state storage. The medium 18 may contain image data, face data, and instructions and programs such as face recognition algorithms and image obfuscation algorithms that are accessible to the processor 16 for executing present principles.

The processor 16 may communicate with a network interface 20 such as but not limited to a wireless telephony transceiver. When embodied as such the interface 20 may be, without limitation, a Global Systems for Mobile communication (GSM) transceiver and variants thereof, code division multiple access (CDMA) transceiver and variants thereof, frequency division multiple access (FDMA) transceiver and variants thereof, time division multiple access (TDMA) transceiver and variants thereof, space division multiple access (SDMA) transceiver and variants thereof, orthogonal frequency division multiplexing (OFDM) transceiver and variants thereof, etc. Or, the interface 20 may be embodied as a Wi-Fi transceiver or as a Bluetooth transceiver. Multiple different interfaces may be employed. Wired interfaces may also be employed. In any case, the camera 10 can communicate using the transceiver 20 with a control computer 22 controlled by one or more processors 24 accessing one or more computer readable storage media 26 to exchange information with the camera 10 through a network interface 28, The control computer 22 may be monitored by security personnel remote from the camera 10 and may present images, potentially obfuscated according to embodiments described below, on a remote display 29 of people imaged by the camera 10.

The camera processor 16 may output visible information on a display 30, which may be a touchscreen display, and receive user input from one or more control elements 32, which may be a physical keypad separate from the display 30 or which may be a virtual keypad presented on a touch sensitive display 30, by way of non-limiting illustration.

FIG. 2 illustrates example logic. Commencing at block 34, the camera 10 takes a still or video image of the person 14. Using face recognition, this captured image is compared to images in a database of images to determine at decision diamond 36 whether the person 14 is recognized. In one embodiment the camera processor 16 executes the determination at decision diamond 36 by accessing a database of images on the camera storage medium 18. In another embodiment the camera processor 16 executes the determination at decision diamond 36 by accessing a database of images on the control computer storage medium 26, using data exchange over the network interfaces 20, 28 to receive the images from the remote database, where they are compared locally to the camera against the person's image. In another embodiment the camera processor 16 uploads the image to the control computer processor 24 and the control computer processor 24 executes the determination at decision diamond 36 by accessing a database of images on the control computer storage medium 26. Preferably, however, image recognition is executed locally on the camera 10 such that obfuscation of recognized faces occurs prior to sending images from the camera 10 to the control computer 22.

If the person 14 is recognized at decision diamond 36, the logic moves to block 38 to obfuscate the image of the face of the person 14. Also, no clear images may be presented locally on the camera or offloaded to the control computer until face recognition has been conducted, after which only obfuscated images of recognized faces may be presented on the camera and/or uploaded to the control computer. As mentioned above, the person's profile and/or back of head may also be tested for recognition and if any one (or in some embodiments only if two or only if all three) of the face, profile, back of head are recognized are the corresponding portions of the image obfuscated. Obfuscation can be effected by, e.g., pixilating the image or masking the image. As examples, the image may be obfuscated by removing N out of M pixels in the original image, presenting only M-N pixels of the original image. Or, the obfuscation at block 38 can be effected by adding to the original image facial features such as a mustache and large eyebrows to hide the face. Other forms of obfuscation can include distorting, e.g., elongating or squashing, the face in the image.

In some embodiments, the obfuscation of the person's image at block 38 is executed by the camera processor 16. In other less preferred embodiments, the obfuscation is executed by the control computer processor 24. In any case, at block 40, assuming that image obfuscation has occurred on board the camera 10 prior to uploading the original image to the control computer 22, the camera 10 uploads the obfuscated image to the control computer 22. Both the camera 10 and control computer 22 may display and/or store the obfuscated image. Also, the camera 10 may store the original image locally, encrypting it if desired so that law enforcement operating under a warrant can obtain the keys to decrypt and view the image of the face prior to obfuscation. The keys can be known to the manufacturer of the camera. It is to be appreciated that when the obfuscation is done locally at the camera 10, surveillance personnel viewing the remote control computer 22 can never see the person's face in the clear (absent a court order to retrieve and decrypt the original image), but can see what the person is doing. In this way, people being surveilled have privacy.

On the other hand, when the imaged person 14 is not recognized at decision diamond 36, the original image may not be obfuscated at block 42, with the original image uploaded to the control computer 22 at block 40. In this way strangers on the scene can be viewed by security personnel viewing the display 29 of the control computer 22 but cannot see the faces in the clear of camera-recognized people being imaged.

In addition to or in lieu of the above, recognition for obfuscation purposes may be based on one or more of the following. Obfuscation may be based on recognizing a generic individual, i.e., obfuscating the image of any individual human that appears in the camera's field of view. Obfuscation may be based on recognizing an individual as being part of a group designated for being obfuscated (youth, adult). Obfuscation may be based on recognizing an individual as being part of a marked group (e.g., wearing an armband or badge, certain colored clothes, etc.) Obfuscation may be based on recognizing a specific individual (face feature matches one in a database).

The depth of obfuscation can be the face only, other portions of the head, the torso alone or with the face, the entire body (such that the using the obfuscated image, nothing can be ascertained of the individual including whether the individual is male or female, only that an individual exists in the image).

Obfuscation may depend on the individual's distance from camera, the location of camera (if in a place of business or public place, obfuscate, otherwise do not obfuscate), the purpose of camera (if voyeuristic, obfuscate, if for security, do not obfuscate).

The camera employed by present principles may need to recognize multiple individuals. Other aspects that will make the determination break for obfuscation include whether the imaged individual is nude or making vulgar gestures. An imaged person can wave to the camera which when interpreted by the processor as being a wave, causes the processor to turn off obfuscation and produce a clear image of the person.

While the particular SURVEILLANCE CAMERA THAT RESPECTS PRIVACY is herein shown and described in detail, it is to be understood that the subject matter which is encompassed by the present invention is limited only by the claims.

1-8. (canceled)

9. A device comprising:
at least one computer memory that is not a transitory signal and that comprises instructions executable by at least one processor for:
receiving at least one clear image of a person;
determining whether a specific face is not recognized using the clear image at least in part by comparing the clear image to a database of specific faces;
responsive to a determination that a face is not recognized, obfuscating at least a portion of the clear image corresponding to the person's face to render an obfuscated image that is not recognizable by a person viewing the obfuscated image.

10. The device of claim 9, wherein the instructions are executable for determining whether the person is recognized using a face recognition algorithm.

11. The device of claim 9, wherein the instructions are executable for determining whether the person is recognized by comparing the capture image to images in a remote database of images.

12. The device of claim 9, wherein the instructions are executable for determining whether the person is recognized by comparing the captured image to images stored on the camera.

13. The device of claim 9, wherein the instructions are executable for determining whether the person is recognized by comparing a portion of the clear image corresponding to the person's profile to images in a database.

14. The camera device of claim 9, wherein the instructions are executable for determining whether the person is recognized by comparing a portion of the clear image corresponding to the back of the person's head to images in a database.

15. The device of claim 9, wherein the instructions are executable for obfuscating the clear image by pixelating the clear image.

16. The device of claim 9, wherein the instructions are executable for obfuscating the clear image by masking the clear image.

17. The device of claim 9, wherein the instructions are executable for obfuscating the clear image by adding at least one facial feature to the clear image.

18. The device of claim 9, wherein the instructions are executable for encrypting the portion of the image corresponding to a person's face.

19. The device of claim 9, comprising the at least one processor.

20. The device of claim 9, comprising an imaging device.

21. The device of claim 19, comprising an imaging device configured for being controlled by the at least one processor.
